(19) United States
(12) Patent Application Publication
(10) Pub. No.: US 2025/0108722 A1
(43) Pub. Date: Apr. 3, 2025

(54) AGGREGATED VEHICLE CHARGE SESSION INFO AS AN INPUT INTO ELECTRIC VEHICLE TRIP PLANNING

(71) Applicant: Rivian IP Holdings, LLC, Irvine, CA (US)

(72) Inventors: Colin William Crenshaw, Portola Valley, CA (US); Grayson Nile Eady, Torrance, CA (US); Gabriel Ulysses Lopez, Torrance, CA (US); Evelyn Anne Fisher, Bozeman, MT (US); Anmol Garg, San Francisco, CA (US)

(21) Appl. No.: 18/476,447

(22) Filed: Sep. 28, 2023

(51) Int. Cl. B60L 53/66

(52) U.S. Cl. CPC B60L 53/66; B60L 2240/72

(57) ABSTRACT

A system including one or more processors is provided. The one or more processors can receive data regarding charging sessions of electric vehicles at a plurality of chargers. The one or more processors can generate a score for each of the plurality of chargers based at least on the data regarding the charging sessions. The one or more processors can generate a path from a current location of a vehicle to a destination that includes a location for each of at least one of the plurality of chargers selected at least based on the scores. The one or more processors can update a user interface to depict the path including the location for each of the at least one of the plurality of chargers.

### INTRODUCTION

A vehicle, such as an electric vehicle, can be powered by batteries. The batteries can be charged by chargers.

### SUMMARY

This disclosure is generally directed to improving electric vehicle (EV) trip planning to account for inaccurate charger data. For example, charging network data provided by charging network operators is often inaccurate. An EV trip planner can use the charging network data to route EVs for charging to reach destinations for trips. In doing so, the EV trip planner may route the EVs to chargers that are not working properly or that charge vehicles slowly, which can result in the EVs not being able to charge or the trips to take substantially longer than initially planned. To improve the selection of chargers to route EVs during trip planning, an EV trip planner may collect and use data regarding charging sessions at the individual chargers to plan a path for a trip. The EV trip planner can collect the data from other EVs being charged in the charging sessions. The EV trip planner can generate metrics from the data regarding the charging sessions. The EV trip planner can use the metrics and/or the raw data itself to generate scores for the different chargers. The EV trip planner can use the scores to select which chargers to route EVs for path planning. Accordingly, the EV trip planner can use historical or real-time charging session data from other electric vehicles to initiate a trip that requires charging the EV before the EV reaches a trip destination, increasing the speed or reliability of the selected path in causing the EV to arrive at the destination quickly.

At least one aspect is directed to a system. The system can include one or more processors. The one or more processors can be coupled with memory to receive data regarding charging sessions of electric vehicles at a plurality of chargers. The one or more processors can be coupled with memory to generate a score for each of the plurality of chargers based at least on the data regarding the charging sessions. The one or more processors can be coupled with memory to generate a path from a current location of a vehicle to a destination that includes a location for each of at least one of the plurality of chargers selected at least based on the scores. The one or more processors can be coupled with memory to update a user interface to depict the path including the location for each of the at least one of the plurality of chargers.

At least one aspect is directed to a method. The method can include receiving, by one or more processors, data regarding charging sessions of electric vehicles at a plurality of chargers. The method can include generating, by the one or more processors, a score for each of the plurality of chargers based at least on the data regarding the charging sessions. The method can include generating, by the one or more processors, a path from a current location of a vehicle to a destination that includes a location for each of at least one of the plurality of chargers selected at least based on the scores. The method can include updating, by the one or more processors, a user interface to depict the path including the location for each of the at least one of the plurality of chargers.

At least one aspect is directed to a vehicle. The vehicle can include one or more processors coupled with memory to receive an identification of a destination. The vehicle can include one or more processors coupled with memory to determine a path from a current location of the vehicle to the destination. The path can be determined according to a score for each of a plurality of chargers based at least on data regarding charging sessions performed at the plurality of chargers, the path including a location for each of at least one of the plurality of chargers selected at least based on the scores. The vehicle can include one or more processors coupled with memory to display the path including the location for each of the at least one of the plurality of chargers.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an electric vehicle, in accordance with the present embodiments.

FIG. 2 depicts a system to manage electric vehicle charging during path planning, in accordance with present implementations.

FIG. 3 depicts a system to manage electric vehicle charging during path planning, in accordance with present implementations.

FIG. 4 depicts an example user interface illustrating a path for an electric vehicle, in accordance with present implementations.

FIG. 5 depicts a method of managing electric vehicle charging during path planning, in accordance with present implementations.

FIG. 6 depicts a method of updating a user interface based on real-time charging session data, in accordance with present implementations.

FIG. 7 depicts a method of managing electric vehicle charging during path planning, in accordance with present implementations.

FIG. 8 depicts a method of managing electric vehicle charging during path planning, in accordance with present implementations.

FIG. 9 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of electric vehicle charging management. The various concepts introduced above and discussed in greater detail below may be implemented in any of numerous ways.

This disclosure is generally directed to improving electric vehicle (EV) trip planning to account for inaccurate charger data. For example, charging network data provided by network operators is often inaccurate, and at best optimistic. When an EV initiates a trip that requires charging the EV to enable the EV to reach a trip destination, an EV trip planner can use charging network data provided by network operators to select which chargers to route the EV for charging during the trip. However, the EV trip planner can select chargers only as accurately as the data inputs the EV trip planner receives from the network operators, which can be inaccurate or misleading.

A data processing system implementing the systems and methods described herein can implement or execute an EV trip planner that uses data from historical charging sessions at the chargers for improved trip planning. For example, when electric vehicles charge at different chargers, the electric vehicles can collect and transmit data regarding the charging sessions to the data processing system. In doing so, the electric vehicles can transmit geolocation data, charging session success or failure cause data, temperature sensor data, or current delivered data, for example, to the data processing system. The data processing system can aggregate the data into metrics such as, for example, actual delivered power for a given temperature, geolocation of the vehicle, time to begin a session after entering the area around the charger, and charger health. The metrics can be fed, in some cases with other charger data, into the EV trip planner to create a trip plan that includes a path from the current location of a vehicle to a destination for the electric vehicle with one or more chargers on the path to use for charging. The trip plan can be more accurate than trip plans generated without charging session data because the trip plan can be generated based on real-time data indicating how the chargers are currently performing. For instance, the data processing system can generate a trip plan based on actual measured potential charge rates, provide navigation to accurate charger locations, avoid chargers with poor health to avoid out-of-service chargers, or account for chargers with higher or lower than normal average times to begin a charging session (which can be caused by slow or cumbersome payment processes or slow charging rates). The data processing system can transmit the trip plan to the electric vehicle for which the data processing system generated the trip plan. The electric vehicle can update a display to depict the trip plan or automatically operate to follow the trip plan.

To use the data regarding charging sessions (e.g., charging session data) for trip planning, the data processing system may generate a score from the data. The score can be a value (e.g., a numerical value) that indicates a reliability or health of the charger for which the score was generated. The data processing system can generate the score based on the data using a function, such as an average, a weighted average, a sum, a weighted sum, or a median, on a combination or sub-combination of the data regarding charging sessions for the chargers or the metrics generated from the data. Responsive to receiving a request for a path from a current location of an electric vehicle to a destination, the data processing system can input the scores for the chargers into another function or algorithm that is configured to determine added times (e.g., time costs) for chargers on a per-trip basis. The data processing system can identify chargers that are within a threshold distance of a path point on a path from the current location of the electric vehicle to the destination. The data processing system can determine added times for the identified chargers based on the drive time to and from the chargers as well as the charging times at the chargers. The data processing system can adjust the added times for chargers or otherwise determine the added times for the chargers based on the scores generated based on the historical charging session data. For instance, the data processing system can increase added times for chargers with lower scores by a larger amount than chargers with lower scores. The data processing system can select chargers with lower added times that enable the electric vehicle to have enough charge to reach the destination. The data processing system can include locations of the selected chargers on the path and update the user interface of the electric vehicle to depict the path including the selected chargers.

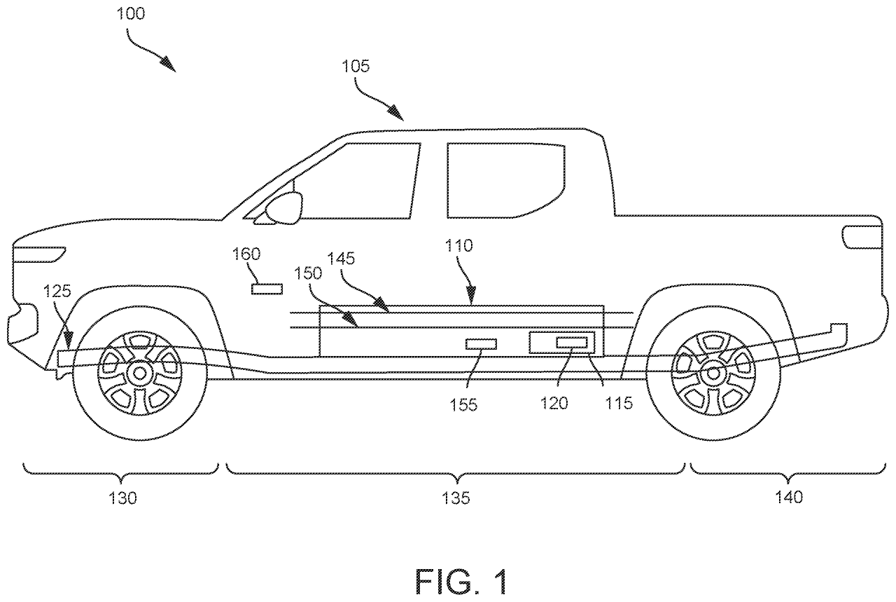

FIG. 1 depicts an example cross-sectional view 100 of a vehicle 105 installed with at least one battery pack 110. The vehicle 105 can be an electric vehicle. The vehicle 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. The vehicles 105 can be fully electric or partially electric (e.g., plug-in hybrid) and further, vehicles 105 can be fully autonomous, partially autonomous, or unmanned. The vehicles 105 can also be human operated or non-autonomous. The vehicles 105 such as electric trucks or automobiles can include on-board battery packs 110, batteries 115 or battery modules 115, or battery cells 120 to power the electric vehicles. The vehicle 105 can include a chassis 125 (e.g., a frame, internal frame, or support structure). The chassis 125 can support various components of the vehicle 105. The chassis 125 can span a front portion 130 (e.g., a hood or bonnet portion), a body portion 135, and a rear portion 140 (e.g., a trunk, payload, or boot portion) of the vehicle 105. The battery pack 110 can be installed or placed within the vehicle 105. For example, the battery pack 110 can be installed on the chassis 125 of the vehicle 105 within one or more of the front portion 130, the body portion 135, or the rear portion 140. The battery pack 110 can include or connect with at least one busbar (e.g., a current collector element). For example, the first busbar 145 and the second busbar 150 can include electrically conductive material to connect or otherwise electrically couple the battery 115, the battery modules 115, or the battery cells 120 with other electrical components of the vehicle 105 to provide electrical power to various systems or components of the vehicle 105.

The vehicle 105 can include an on-board charger 155. The on-board charger 155 can include a port for receiving power from a charger. The on-board charger 155 can receive AC power from a charger or direct AC power from one of the batteries 115 of the vehicle 105 to an external load. The on-board charger 155 can be configured to direct or receive AC power of any voltage or power.

The vehicle 105 can include a controller 160. The controller 160 can include one or more processors and memory. The controller 160 can be configured to control operation of different components of the vehicle 105. In one example, the controller 160 can control the charge and discharge of the on-board charger 155 or the batteries 115 for charging an external load. The controller 160 can control the contactors (e.g., open and close the contactors) of the batteries 115 to enable the batteries 115 to be charged or discharged.

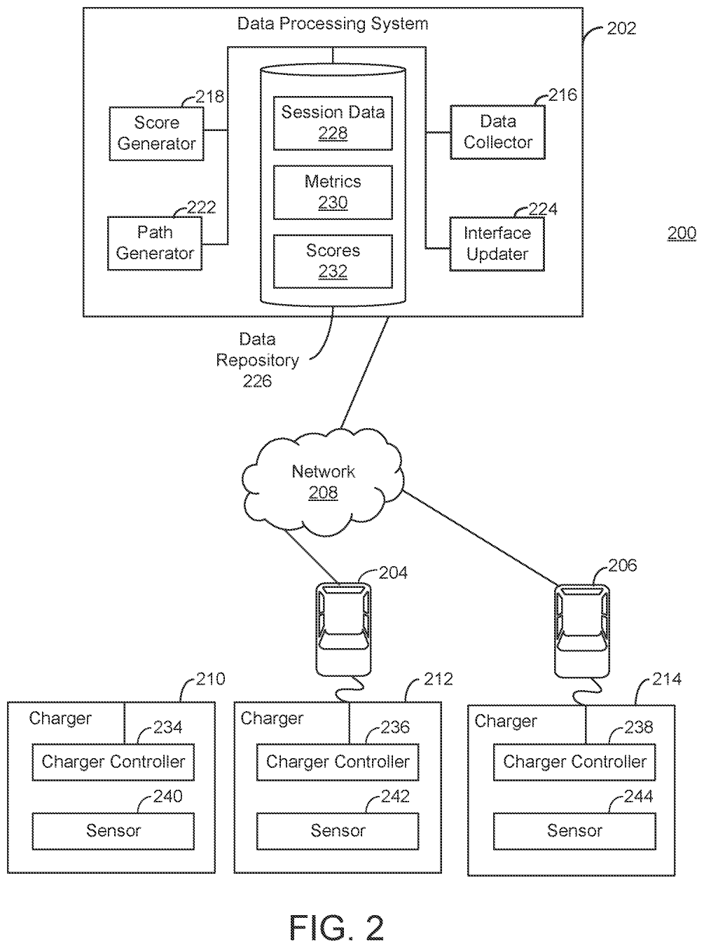

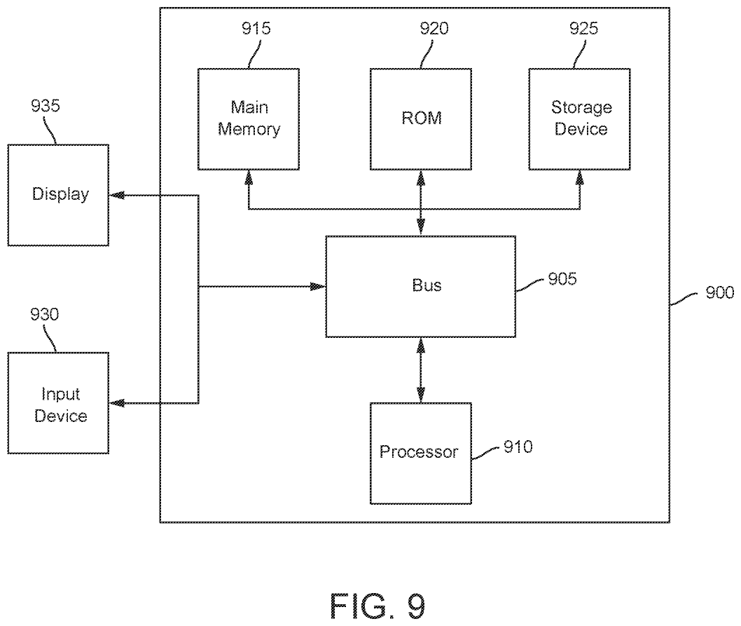

FIG. 2 depicts an example system 200, in accordance with present implementations. The system 200 can include a data processing system 202 in communication with electric vehicles 204 and 206 over a network 208. The data processing system 202 can be the same as or be similar to the computing system 900, shown and described with reference to FIG. 9. The electric vehicles 204 and 206 can be vehicles similar to or the same as the electric vehicle 105, shown and described with reference to FIG. 1. The data processing system 202 can collect data regarding charging sessions (e.g., charging session data or session data) in which electric vehicles charge at different chargers 210, 212, and 214. The data processing system can collect the data from the vehicles (e.g., from the vehicles 204 and 206) and/or the chargers (e.g., the chargers 210, 212, and 214) participating in the charging sessions. The data processing system 202 can use the data to generate paths to destinations that include charging at one or more of the chargers selected based on the data regarding the charging sessions. The data processing system 202 can update a user interface (e.g., a user interface presented on a display of an electric vehicle) to illustrate the path. Accordingly, by implementing the systems and methods described herein, the data processing system 202 can implement improved route planning taking into account real-time charging data.

The data processing system 202 can include or execute on one or more processors or computing devices and/or communicate via the network 208. The chargers 210-214 and/or electric vehicles 204 and 206 can communicate with computing devices (e.g., the data processing system 202) over the network 208. The network 208 can include computer networks such as the Internet, local, wide, metro, or other area networks, intranets, satellite networks, and other communication networks such as voice or data mobile telephone networks. The network 208 can include computer networks such as the Internet, local, wide, metro, or other area networks, intranets, satellite networks, and other communication networks such as voice or data mobile telephone networks. The network 208 can be used to access information resources such as web pages, websites, domain names, or uniform resource locators that can be presented, output, rendered, or displayed on at least one computing device. For example, the data processing system 202 can generate scores for different chargers based on data regarding communication sessions that the data processing system 202 receives over the network 208. Users of electric vehicles can transmit a request over the network for a path to a destination. The data processing system 202 can use the scores to select chargers at which the electric vehicle can charge to include the path to the destination. The data processing system 202 can transmit the path to the electric vehicle to update a user interface shown on a display of the electric vehicle. The user driving the electric vehicle can drive according to the path on the user interface or the electric vehicle can automatically drive according to the path.

The data processing system 202 can include at least one data collector 216. The data processing system 202 can include at least one score generator 218. The data processing system 202 can include at least one path generator 222. The data processing system can include at least one interface updater 224. The data processing system can include at least one data repository 226. The data collector 216, score generator 218, path generator 222, and interface updater 224 can each include at least one processing unit or other logic device such as a programmable logic array engine, or module configured to communicate with the data repository 226 or database. The data collector 216, score generator 218, path generator 222, and the interface updater 224 can be separate components, a single component, or part of the data processing system 202. The data processing system 202 can include hardware elements, such as one or more processors, logic devices, circuits, or memory. The data processing system 202 can be or include one or more cloud servers or can be located on an electric vehicle. In one example, the data processing system 202 can be a controller (e.g., the controller 160) of an electric vehicle and can control the electric vehicle to follow a path generated as described herein.

The data repository 226 can include one or more local or distributed databases, and can include a database management system. The data repository 226 can include computer data storage or memory. The data repository 226 can store state session data 228. The session data 228 can include data regarding charging sessions in which different chargers charge electric vehicles. Examples of the session data 228 include geolocation data, indications of whether charge sessions succeeded or failed, temperature sensor data, or amounts of current delivered over the course of the charging sessions. Data regarding individual charging sessions can be stored in the session data 228 in individual records that each correspond to a different charging session. The records can be stored in files that each correspond to a different charger at which the charging sessions were performed.

The data repository 226 can additionally store metrics 230. The metrics 230 can be metrics for the different chargers. The score generator 218 can generate the different metrics for individual chargers based on session data 228 that is collected for the respective chargers (e.g., from session data 228 in the files for the individual chargers). Examples of different metrics of the metrics 230 can include actual delivered power for a given temperature, geolocation of a vehicle, time to begin a charging session after entering an area around the charger, and charger health. The metrics 230 can be generated from the session data 228 from the files for the individual chargers.

The data repository 226 can store scores 232. The scores 232 can be or include scores for individual chargers. The scores 232 can be or include aggregate scores for the individual chargers. The score generator 218 can generate the scores 232 for the individual chargers based on or as a function of the metrics 230 or the session data 228 for the individual chargers. In doing so, the score generator 218 can use a function such as a sum, weighted sum, average, weighted average, or median, for example. The score generator 218 can use the function on one or more types of session data 228 or metrics 230 generated from the session data 228.

The chargers 210, 212, and 214 can be or include one or more dispensers. The chargers 210, 212, and 214 can be individual dispensers at a charging station or multiple dispensers of a charging station. Each dispenser of a charger can be configured to charge electric vehicles, such as through charging ports on the dispensers of the chargers. Although only three chargers 210-214 are shown in FIG. 2, any number of chargers can be configured to charge electric vehicles in the system 200. The chargers 210-214 can include charger controllers 234, 236, and 238, respectively, and sensors 240, 242, and 244, respectively. The charger controllers 234, 236, and 238 can be configured to charge electric vehicles through charging ports of the chargers 210-214. The charge ports can be ports that electric vehicles can connect to and receive power through. The sensors can be sensors that measure characteristics (e.g., temperature at the charge ports or the amount of current that is being transferred). The sensors 240, 242, and 244 can generate data regarding different charging sessions that are performed at the respective chargers 210, 212, and 214. The sensors 240, 242, and 244 can transmit the generated data to the charger controllers 234, 236, and 238, respectively, or the vehicles 204 and 206 participating in the charging sessions. The charger controllers 234, 236, and 238 or the vehicles 204 and 206 can transmit the received data across the network 208. The data processing system 202 can receive and store the data in the data repository 226 as session data 228.

In operation, the data collector 216 of the data processing system 202 can collect data regarding charging sessions at different chargers. The data collector 216 can collect the data from the electric vehicles (e.g., the electric vehicles 204 and 206) or the chargers (e.g., the chargers 210-214) participating in the charging sessions. The data collector 216 can collect the data across the network 208. The collected data can include, for example, for individual charging sessions, geolocation data, an indication of whether the charging session succeeded or failed, temperature sensor data, or an amount of current that was delivered. The data collector 216 can collect the data as the charging sessions occur or subsequent to the respective charging sessions.

For example, the electric vehicles of the charging sessions can detect that the charging sessions end responsive to charging to a percentage (e.g., a defined percentage) of the battery capacities of the electric vehicles. While the charging sessions occur, the electric vehicles can generate or detect different types of data regarding the charging sessions. The electric vehicles can store the generated data and transmit the generated data to the data processing system 202 responsive to detecting the end of the respective charging sessions. In another example, the electric vehicles can detect times in which payment authorizations are declined or take a long time to complete before the charging sessions begin. The electric vehicles can transmit the times or indications of authorizations or rejections to the data processing system 202 responsive to detecting the authorizations or rejections or responsive to detecting the ends of the charging sessions. The electric vehicles can detect when the electric vehicles initiate charging sessions or otherwise arrive at the respective chargers. Responsive to doing so, the electric vehicles can generate geolocation data of the electric vehicles, such as by using global positioning systems (GPSs) of the electric vehicles, that indicate the current locations of the electric vehicles. The electric vehicles can transmit the geolocation data to the data processing system responsive to detecting the current locations of the electric vehicles or responsive to detecting the end of the charging sessions. In another example, electric vehicles can detect the amount of current or power that is flowing to the electric vehicles during the charging session. The electric vehicles can do so using one or more sensors, such as transducers. The electric vehicles can transmit the amount of current or power to the data processing system. In another example, the electric vehicles can detect temperature data of the respective electric vehicles or the chargers at which the electric vehicles are charging. The electric vehicles can detect the temperature using temperature sensors. The electric vehicles can additionally or instead collect the temperature data of the surrounding environment. The electric vehicles can transmit any collected temperature data to the data processing system 202 as the temperature data is collected or responsive to detecting the end of the charging sessions. The chargers can use similar methods to collect the same or similar data. The chargers can transmit the collected data to the data processing system 202 responsive to detecting the end of the charging sessions and/or as the data is collected.

The data collector 216 can store records for individual charging sessions in the session data 228. For example, the data received from the electric vehicles or chargers can include an identification or identifier of the charging session, the electric vehicle being charged, or the charger (e.g., the dispenser of the charger) that is charging the electric vehicle. The data collector 216 can generate such identifications or identifiers in some cases. The data collector 216 can store the identifiers or identifications in the records for the respective charging sessions, thus indicating charger, electric vehicle, or charging session that pertains to the session data 228 of the respective charging sessions. The data collector 216 can store timestamps indicating when the individual data was generated or received.

The data collector 216 can receive the collected data. The data collector 216 can store the collected data in the data repository 226 as session data 228. The data collector 216 can be or include an application programming interface (API) configured to communicate with electric vehicles or chargers over the network 208. The data collector 216 can be or include an application programming interface (API) that facilitates communication between the different electric vehicles and the data processing system 202 and communication between the chargers (e.g., individual dispensers of the chargers) and the data processing system 202. The data collector 216 can communicate with the electric vehicles or the chargers across the network 208.

The data collector 216 can establish connections with the electric vehicles or the chargers (e.g., the processors of the electric vehicles or chargers, such as the charger controllers 234-238, respectively, or the controllers 160 of the electric vehicles). The data collector 216 can establish the connections over the network 208. To do so, the data collector 216 can communicate with the electric vehicles or the chargers across the network 208. In one example, a charger or an electric vehicle can transmit a syn packet to the data collector 216 (or vice versa) responsive to the electric vehicle connecting with the charger for a charging session. Through the syn packet, the data collector 216 can establish the connection using a TLS handshaking protocol, for example. The data collector 216 can use any handshaking protocol to establish such connections.

The score generator 218 can generate scores for the individual chargers. The scores can indicate a level of performance (e.g., a current level of performance) of the individual chargers. The score generator 218 can generate the scores based on session data 228 for the individual chargers. For example, the score generator 218 can identify the records containing session data 228 for the individual chargers. The score generator 218 can retrieve session data 228 for the chargers from the individual records. The score generator 218 can execute a function, such as a sum, an average, a weighted sum, a weighted average, a median, etc., on the session data 228 for each of the chargers. The score generator 218 can generate the scores by inputting the session data 228 into a machine learning model (e.g., a neural network, a support vector machine, or a random forest) trained to generate scores for chargers based on session data. The score generator 218 can generate the scores by executing the machine learning model based on the inputs for the individual chargers. The outputs of the executions of the machine learning model or functions can be or include a separate score (e.g., a numerical value) for each of the chargers. Accordingly, the score generator 218 can generate scores for the separate chargers.

To generate the scores, the score generator 218 can aggregate or otherwise combine session data 228 of the same type together. For example, the score generator 218 can combine session data 228 into metrics 230 for the individual chargers. The metrics 230 can be aggregate representations of specific types of session data 228 for the individual chargers. The metrics 230 can be or include actual delivered power for a given temperature, geolocation of a vehicle, time to begin charging session after entering an area around the charger, and charger health. The score generator 218 can determine actual power delivered for a given temperature by calculating an average power delivered for different temperatures or ranges of temperatures from the current or power delivered session data 228 that the data collector 216 collects. The score generator 218 can combine (e.g., calculate an average, sum, or median) the different calculated values to create a single metric or keep the metrics separate for the different temperatures or temperature ranges. The score generator 218 can use geolocation data of the session data 228 to determine the actual locations of the different chargers. For example, the score generator 218 can determine a location of a charger responsive to determining multiple (e.g., a defined number of two or greater) charging sessions indicate the same location of the same charger.

The score generator 218 can determine the average time to begin a charging session after entering an area surrounding a charger using geolocation data and/or indications of a successful authorization for payment. For example, the score generator 218 can identify geolocation data for a charging session indicating when an electric vehicle entered a radius (e.g., a defined radius) of a vehicle. The score generator 218 can identify a timestamp of the geolocation data. The score generator 218 can also identify a timestamp indicating a successful authorization (e.g., payment authorization) for the charging session. The score generator 218 can determine a difference between the timestamps to determine a time to initiate a charge. The score generator 218 can perform this process for each charging session for a charger. The score generator 218 can calculate an average of the differences to determine the metric 230 indicating the time to begin a session after entering the area around a charger. The score generator 218 can determine a similar metric 230 for each of the chargers.

The score generator 218 can determine a speed of charging metric. The score generator 218 can do so by determining differences between a timestamp indicating a vehicle entered the area of a charge and a timestamp indicating the charging session successfully ended or timestamps indicating a vehicle began charging or was authorized to charge and successfully stopped charging. Other examples of metrics 230 that the score generator 218 can determine from session data 228 can be a percentage of successful payment authorizations, average current delivered during the charging sessions, percentage of failed charging sessions, or percentages of failed charging sessions for different types or causes of failures. The score generator 218 can generate any number of types of metrics 230 for individual chargers. The score generator 218 can store the metrics 230 in the data repository 226 as the score generator 218 generates the metrics 230.

The score generator 218 can determine scores for the individual chargers for which the data processing system 202 received data regarding charging sessions. The score generator 218 can determine the scores as a function (e.g., a sum, a weighted sum, an average, a weighted average, or a median) of or executing a machine learning model based on the session data 228 regarding the charging sessions performed at the individual chargers, the metrics 230 determined based on the session data 228, or a combination of the session data 228 and the metrics 230 for the same chargers. The score generator 218 can retrieve the session data 228 or the metrics 230 for each individual charger and use the retrieved session data 228 or metrics 230 to determine or generate a score for each of the chargers. The score generator 218 can store the determined scores in the data repository 226 as the scores 232.

The score generator 218 can determine and store scores for individual chargers for different conditions. For example, the score generator 218 can determine scores for different outside air temperatures or ranges of outside air temperatures. To do so, the score generator 218 can retrieve the session data 228 or metrics 230 for charging sessions that occurred at the specific outside air temperatures or at (e.g., within) the ranges of outside air temperatures. The score generator 218 can generate scores for the chargers for the respective outside air temperatures or ranges or outside air temperatures. In another example, the score generator 218 can determine scores for different times or time periods. To do so, the score generator 218 can retrieve the session data 228 or metrics 230 for charging sessions that occurred at the specific times or at the specific time periods. The score generator 218 can generate scores for the chargers for the respective times or time periods. The score generator 218 can determine such scores for any condition. The score generator 218 can determine scores for different permutations of conditions.

The scores can be health scores for the individual chargers. The health scores can be generated based on session data 228 or metrics 230 that indicate the health of the charger itself rather than a payment processor or a popularity or congestion of using the charger. The score generator 218 can determine the health scores based on or as a function of a defined subset of session data 228 or metrics 230. For example, the score generator 218 can determine the health scores based on a percentage of successful charging sessions that were successfully authorized and the length of time of successful charging sessions. The health scores may not be based on successful payment authorizations or other metrics that do not correspond with the charger's ability to charge electric vehicles or the time between arrival and beginning a charging session or ending a charging session because such session data 228 or metrics 230 can relate to the popularity or congestion of the charger or the payment process rather than the charger itself. The score generator 218 can determine health scores for chargers based on any combination of session data 228 or metrics 230. The score generator 218 can generate the health score in addition to another score that the score generator 218 generates based at least one metrics 230 or session data 228 that the score generator 218 excludes from the determination of the health scores. There can be overlap in the session data 228 or metrics 230 that are used to generate the health scores and scores for the chargers.

The score generator 218 can dynamically update the scores for the chargers over time. For example, over time, the data collector 216 can collect data regarding sessions at different chargers. The score generator 218 can calculate scores for the chargers at set time intervals using a moving time window (e.g., a time window having a defined length ending at the current time) to determine the session data 228 with which to generate the scores. The score generator 218 can retrieve session data 228 that has timestamps within the moving time window and generate metrics 230 or scores 232 from the retrieved data. The score generator 218 can store the metrics 230 and scores 232 in the data repository 226. After a time interval (e.g., a defined time interval) or responsive to receiving a request to do so, the score generator 218 can repeat the process and determine metrics 230 or scores 232 from session data 228 of the time window moved to end at the current time. The score generator 218 can replace the scores for the chargers with the newly determined scores or add the new scores to data structures (e.g., tables) for the separate chargers to keep a record of the scores for the chargers. The score generator 218 can repeat the process any number of times. In doing so, the score generator 218 can account for sudden changes in state or behavior of the chargers that can impact the chargers' performance.

For example, the data collector 216 can receive, during a first time period, first data regarding charging sessions of electric vehicles at the chargers. The score generator 218 can generate first scores for each of the chargers based at least on the first data regarding the charging sessions. The score generator 218 can store the first scores for the chargers in memory of the data processing system 202. The data collector 216 can receive, during a second time period (e.g., a time period subsequent to the first time period), second data regarding charging sessions of electric vehicles at the chargers. The score generator 218 can generate a second score for each of the chargers based at least on the second data regarding the charging sessions. The score generator 218 can replace the first scores for the chargers in memory of the data processing system 202 with the second scores for the chargers in the memory of the data processing system 202.

The path generator 222 can use the scores 232 for the chargers to generate a path for an electric vehicle to travel from a current or initial location to a destination. For example, the path generator 222 can receive a request from an electric vehicle (e.g., the electric vehicle 105) for a path or directions from the current location of the electric vehicle to a destination. The path generator 222 can receive such a request over the network 208. Responsive to receiving the request, the path generator 222 can identify one or more routes from the current location of the vehicle to the destination, such as by querying a stored map of roads and determining different turns the electric vehicle could take to arrive at the destination. The path generator 222 can determine different characteristics of the different paths, such as the total amount of time following the path would take, in some cases based on the traffic of the path, the amount of traffic of the path, the time of arrival of the path, and the amount of energy that would be required to take the path. The path generator 222 can determine such characteristics based on stored historical data or based on different stored rules that can be stored in memory of the data processing system. To determine traffic, the path generator 222 can determine the speed of other vehicles on the path such as based on location data of the vehicles over time or determine the number of vehicles that are on each path. To determine the amount of energy, the path generator 222 can use a function characterized by different variables, such as changes in elevation, speed, and amount of starting and stopping. The path generator 222 can determine the time of arrival or the time to take the path based on the distance, speed limits, and traffic of the path. The path generator 222 can select a path that will cause the electric vehicle to arrive at the destination in the shortest amount of time.

The path generator 222 can determine whether to include chargers that the electric vehicle can use for charging on the path. For example, the electric vehicle can include a current state of charge and a maximum state of charge in the request to the path generator 222. The path generator 222 can determine whether following the selected path from the electric vehicle's current location to the destination will cause the state of charge of the vehicle to reach zero or a value below a threshold (e.g., a predetermined threshold). Responsive to determining the state of charge will not equal zero or an amount below the threshold, the path generator 222 can select the path and the interface updater 224 can display the path on a user interface (e.g., a user interface displayed on a display of the electric vehicle or a computing device within the electric vehicle).

However, responsive to determining taking the path will cause the state of charge of the electric vehicle to reach zero or a value below the threshold, the path generator 222 can select at least one charger at which the electric vehicle can charge when traveling to the destination. The path generator 222 can select the at least one charger by determining an added time for each charger that is within a defined distance of a point on the path. For example, the path generator 222 can store a list of chargers in memory with the locations (e.g., locations determined based on the session data 228) of the chargers. The path generator 222 can use a distance formula to determine the shortest distances between the chargers and a point on the path. The path generator 222 can identify any chargers that are a distance below a threshold from at least one point on the path. The identified chargers can be a subset of the chargers that are between the current location of the vehicle and the destination.

The path generator 222 can determine an added time (e.g., a time cost) for each of the chargers that the path generator 222 identified as being a distance below a threshold from a point on the path. The added time can be the amount of time using the charger would add to a trip than if the charger were not to be used. The path generator 222 can determine an added time for the chargers based at least on the scores 232 most recently generated by the score generator 218. For example, the path generator 222 can determine (e.g., only determine) a total added time for each charger identified as being within a threshold distance of a point on the selected path (e.g., identified as being a part of the subset of chargers). The path generator 222 can determine an added time for a charger, for example, as a function of or based on any combination, sub-combination, or permutation of the score (e.g., an aggregate score determined based on the session data 228 or the metrics 230 for the charger), a health score (e.g., a score determined based on a defined subset of the session data 228 or the metrics 230 for the charger, such as a percentage of failed charging sessions), a maximum current, a successful charge percentage, an average charging session length of the chargers, or an average amount of current delivered during charging sessions. The path generator 222 can determine the added time for a charger, for example, by retrieving session data 228, the metrics 230, or the score 232 for the charger from the data repository 226 and using a function such as a sum, average, weighted sum, weighted average, or a median on the data.

The path generator 222 can retrieve the most recently generated scores, metrics, or data regarding charging sessions for the chargers. The path generator 222 can retrieve the scores that correspond to the current conditions (e.g., temperature or time) or that correspond to the conditions when the electric vehicles would reach the chargers associated with the scores. The path generator 222 can determine the temperature using a weather forecast, for example. The path generator 222 can determine a total amount of time added with the travel off of the path to the charger to include in the added time. The path generator 222 can identify values from specifications provided by the chargers themselves or the owners of the charging network of the chargers to determine the added times for the chargers. A specification for a charger can indicate an expected amount of current or power the charger is configured to provide during charging sessions, such as the amount of power or current the charger is manufactured to provide. The path generator 222 can predict a charge time for each of the chargers based on the amount of current with which each charger is configured to charge vehicles. The path generator 222 can use each or a combination of the retrieved, determined, or identified data to determine or generate added times for the chargers using a function on the data.

The path generator 222 can use an optimization function to select chargers (e.g., locations of selected chargers) to include in the path from the current location of the electric vehicle to the destination for the electric vehicle. The path generator 222 can do so based on the added times the path generator 222 determines for each of the chargers based at least on the scores for the chargers. The path generator 222 can identify chargers to use to charge the electric vehicle to minimize the added time over the course of the path while ensuring the electric vehicle does not run out of energy to reach the destination. Because the path generator 222 can use scores generated based on real-time or historical charging session data, the path generator 222 can determine a more efficient or faster path than a system that relies only on charger specification data to determine which chargers to use to charge an electric vehicle in path planning. Upon selecting the path, the path generator 222 can update the path to include any detours to locations of the selected chargers in the path.

The path generator 222 can use added times of chargers to initially select a path from a current location of a vehicle to a destination. For example, instead of selecting a path based only on different characteristics, such as total time or distance traveled, the path generator 222 can also take into account the added times of chargers and include locations of selected chargers in the initial path from a current location of a vehicle to a destination. The path generator 222 can do so, for example, by determining different paths that include the chargers. The path generator 222 can determine characteristics of the paths such as the total distance and time of arrival but taking into account the added times of the chargers of the path. The path generator 222 can determine paths with different chargers and identify a path with the shortest distance or the earliest time of arrival. The chargers on the selected path can be selected based on the scores because the added times of the chargers can be determined based on the scores.

The interface updater 224 can update a user interface with the selected path. For example, the interface updater 224 can transmit the selected path back to the electric vehicle that requested the selected path. The interface updater 224 can transmit the selected path to a computing device (e.g., a mobile computing device, such as a cellular phone or a tablet) being accessed by an individual in an electric vehicle. The electric vehicle can receive the path and update a user interface on a display of the electric vehicle to show the selected path. The electric vehicle can show the selected path on an overhead map showing the electric vehicle traveling from the current location to the destination in real time. The interface updater 224 can include auditory instructions with the selected path that the electric vehicle can play through a speaker to give the driver instructions to follow the selected path. The user interface can depict visual indicators of the selected chargers and the path to reach the chargers for charging and then continuing to the destination. An individual in the electric vehicle can view the selected path on the user interface and drive to the destination according to the selected path.

The electric vehicle can automatically or autonomously follow the selected path. For example, instead of or in addition to displaying the selected path on the user interface, a controller of the electric vehicle can ingest the selected path as instructions and autonomously control the electric vehicle to follow the selected path. Responsive to receiving the selected path, the electric vehicle can begin following the selected path, making any turns or stops as necessary to comply with applicable law.

The interface updater 224 can update a user interface of the electric vehicle based on session data 228, metrics 230, or scores 232. For instance, the user interface of the electric vehicle can include indications or identifications of different chargers on an overhead map. The interface updater 224 can transmit instructions to update the overhead map based on data regarding charging sessions at the individual chargers. For example, the interface updater 224 can transmit instructions to the electric vehicle to display scores (e.g., aggregate scores or health scores) for the chargers adjacent or next to the indications of the chargers. In another example, the interface updater 224 can transmit instructions to adjust the translucence or appearance of the indications of the chargers based on the scores, such that higher scores equate to darker indications and lower scores equate to lighter indications. In another example, the interface updater 224 can transmit instructions to display a total wait time of the last completed charging session for each charger. In another example, the interface updater 224 can transmit instructions to cause any chargers with a score below a threshold to not appear on the user interface. In another example, the interface updater 224 can transmit instructions to cause indications of chargers to appear in different colors depending on the ranges of the scores. The electric vehicle can receive the instructions and update the user interface accordingly. The interface updater 224 can adjust the indications of the chargers over time as the data collector 216 collects session data 228 and the score generator 218 generates new scores for individual chargers. In one example, the interface updater 224 can adjust the visual indicators for the chargers proportional to the scores for the chargers (e.g., increase the translucence by an amount proportional to a decrease in the score from a previous score for the same charger).

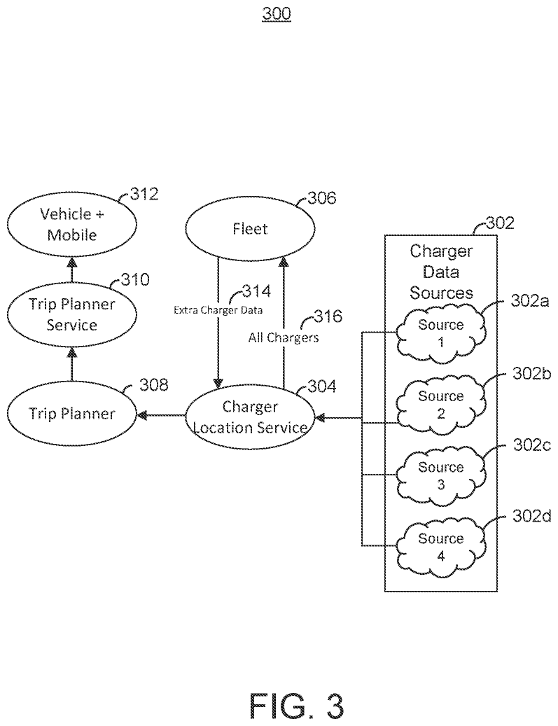

FIG. 3 depicts a system 300 to manage electric vehicle charging during path planning, in accordance with present implementations. The system 200 can include a data processing system (e.g., the data processing system 202, shown and described with reference to FIG. 2, a client device, a computer, or a plurality of computers) in communication with different charging network providers 302a-d (together, charging network providers 302, and, separately, charging network provider 302). The charging network providers 302 can be or include computers that transmit data (e.g., specification data) regarding operation of the chargers that the respective charging network providers 302 operate or manage to the data processing system. The data processing system can execute a charger location service 304 to collect data regarding charging sessions of electric vehicles at different chargers from the chargers or the electric vehicles (together, a fleet 306) participating in the charging sessions as well as the charging network providers 302 that manage the chargers. The data processing system can execute a trip planner 308 to generate a path from a current location of an electric vehicle to a destination for the electric vehicle. The trip planner 308 can do so using the data collected from the charging network providers 302 or the fleet 306 to select the chargers to include in the path for charging. The data processing system 336 can execute a trip planner service 310 to transmit the path including the selected chargers to a vehicle or computing device 312.

For example, over time, the data processing system can receive data 314 regarding charging sessions of electric vehicles at different chargers from the fleet 306 or data 316 regarding the chargers themselves from the charging network providers 302. The data processing system can execute the trip planner 308 using one or both of the data 314 or the data 316 to generate or determine scores for the individual chargers, such as by using a function on the data 314 or 316. The data processing system can store the scores in memory. The data processing system can receive a request from an electric vehicle or a computing device (e.g., a mobile computing device, such as a cellular phone or a table) for directions to drive the electric vehicle from the current location to a destination. Responsive to receiving the request, the data processing system can execute the trip planner 308 to retrieve the most recently generated scores from memory and generate a path from the current location of the electric vehicle to the destination that includes one or more chargers selected based on the scores for the chargers. The data processing system can execute the trip planner service 310 to transmit the path to the electric vehicle or computing device. The electric vehicle or computing device can receive the path and update a user interface on a display to show the path to the destination including the selected chargers.

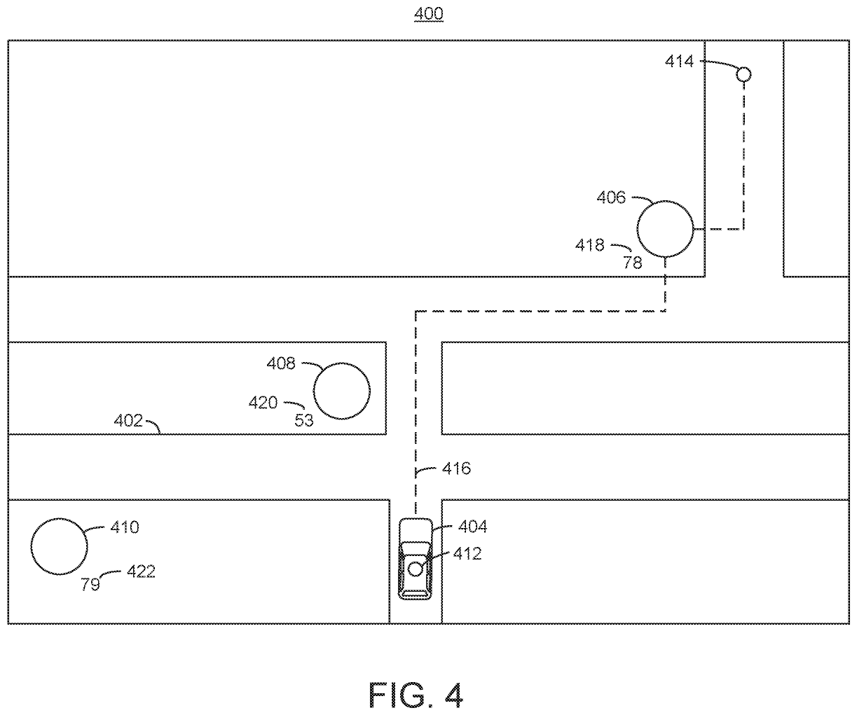

FIG. 4 depicts an example user interface 400 illustrating a path for an electric vehicle, in accordance with present implementations. A data processing system (e.g., the data processing system 202, shown and described with reference to FIG. 2, a client device, a computer, or a plurality of computers) can generate or update the user interface 400. The user interface 400 can be displayed on a display of an electric vehicle or a display on a computing device. The user interface 400 can illustrate a path for an electric vehicle to travel from a current location to a destination. A user driving an electric vehicle can view the user interface 400 to use as directions to reach the destination. A controller of the electric vehicle can automatically control the electric vehicle according to the path.

For example, the user interface 400 can illustrate an overhead view of a road 402 on which an electric vehicle 404 is driving. The user interface 400 can also include locations of chargers 406, 408, and 410. The chargers 406, 408, and 410 can include one or more dispensers to charge electric vehicles. The data processing system can receive a request from the electric vehicle 404 for a path to travel from a current location 412 of the electric vehicle 404 to a destination 414. The data processing system can receive the request and use previously determined scores for the chargers 406, 408, and 410 to determine a path 416 for the electric vehicle 404 that includes at least one stop at a charger for charging such that the electric vehicle 404 can reach the destination 414. The data processing system can update the user interface 400 to depict the path 416, including a stop at the charger 406. The data processing system can have selected to charge the electric vehicle 404 at the charger 406 instead of the chargers 408 or 410 because the charger 406 has a score that caused the charger 406 to result in a lower added time value than the chargers 408 and 410, for example. The user driving the electric vehicle 404 can view the path 416 and drive to the destination according to the path 416. A controller of the electric vehicle 404 can identify the path 416 and automatically drive the electric vehicle to the destination 414, stopping at the charger 406 for charging along the way.

The data processing system can update the user interface 400 to include data regarding the chargers 406, 408, and 410. For example, the data processing system can generate scores for the chargers 406, 408, and 410 based on the data regarding charging sessions. The data processing system can display visual indications of the scores adjacent to the chargers 406, 408, and 410 for which the scores were generated as scores 418, 420, and 422, respectively. The data processing system can transmit the visual indications to the electric vehicle or computing device displaying the user interface 400 to display the visual indications or can update a display itself when the data processing system includes a processor that generates and displays the user interface 400. The data processing system can display the visual indications of the scores in any manner. For example, instead of or in addition to displaying the scores themselves, the data processing system can display the indications of the chargers 406, 408, and 410 in different colors on the user interface 400 that correspond to the scores (e.g., scores between 1 and 10 can be red, scores between 11 and 20 can be orange, and scores between 21 and 30 can be green). In another example, the data processing system can cause the indications of the chargers to be more or less visible on the screen depending on the determined scores for the indications. For example, the data processing system can cause lower scoring chargers to have a high translucence and higher scoring chargers to have a low translucence. The data processing system can update the user interface 400 such that only chargers with scores above a threshold appear on the user interface 400. The data processing system can update the user interface 400 based on the scores of the chargers in any manner. The data processing system can adjust the visual indications over time as the data processing system determines new scores for the chargers. The data processing system can adjust the visual indications proportional to the new scores for the chargers.

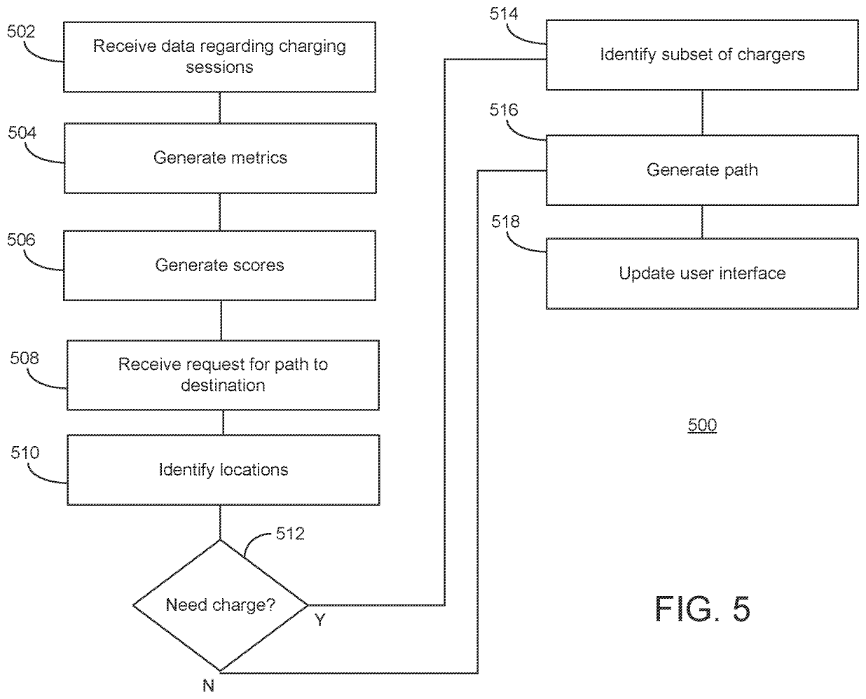

FIG. 5 depicts a method 500 of managing electric vehicle charging during path planning, in accordance with present implementations. The method 500 can be performed by one or more components depicted in the system 200 of FIG. 2 or the computing device 900 of FIG. 9. For example, the method 500 can be performed by a data processing system (e.g., the data processing system 202, shown and described with reference to FIG. 2). Performance of the method 500 can allow the data processing system to use data regarding charging sessions for path planning. The data processing system can perform the method 500 as a controller of an electric vehicle, as a cloud server, or as a combination of a controller of an electric vehicle and cloud server that communicate with each other.

At ACT 502, the method 500 can include receiving data regarding charging sessions. The data regarding charging sessions can be any type of data, such as geolocation data, an indication of whether the charging session succeeded or failed, temperature sensor data, or an amount of current that was delivered during the charging session. The data processing system can receive data regarding charging sessions from the electric vehicles being charged or the chargers charging the electric vehicles. The data processing system can receive the data at the end of the respective charging sessions or as the charging sessions are occurring. The data can include identifications of the vehicles participating in the charging sessions or identifications of the chargers charging the vehicles.

At ACT 504, the method 500 can include generating metrics. The data processing system can generate metrics for each charger for which the data processing system receives data regarding charging sessions. The metrics can be or include aggregate representations of specific types of data regarding charging sessions performed by individual chargers. The metrics can be or include actual delivered power for a given temperature, geolocation of a vehicle, time to begin charging session after entering an area around the charger, and charger health. The data processing system can generate the metrics by identifying the data of the same type for a charger and aggregating or performing a function, operation, rule, or condition on the data. For example, the data processing system can determine the average actual power delivered at different temperatures based on charging sessions that are performed at the different temperatures. The data processing system can determine the geolocation of a charger based on geolocation data from multiple vehicles that contains an identification of the charger for a charging session having the same coordinates or location. The coordinates can be the location of the charger. The data processing system can determine the time to begin charging session after entering an area around the charger by identifying a timestamp indicating when a vehicle enters a location of a charger (e.g., a determined location based on data of other charging sessions) and a timestamp indicating when the charging session began and determining a difference between the two timestamps. The data processing system can determine an average of the differences to determine the metric. The data processing system can determine the charger health as a ratio or percentage of the number of charging sessions that began and completed. The data processing system can determine or generate any number of metrics for charging sessions.

At ACT 506, the method 500 can include generating scores. The data processing system can generate a score for each charger for which the data processing system receives data regarding charging sessions. The data processing system can generate the scores based on or as a function of the data regarding charging sessions or the metrics that the data processing system generates based on the data regarding charging sessions. For example, the data processing system can determine an average, sum, weighted average, weighted sum, a median, or any other function on all or a subset of the data regarding charging sessions or the metrics to generate scores for the chargers. The scores can be health scores or the data processing system can determine health scores in addition to the scores. For example, the data processing system can generate health scores for the chargers based on or as a function of metrics such as a number of successful charging sessions that begin or an average amount of power or current that is delivered in the charging sessions of the chargers. The data processing system can store the scores or health scores in memory or in a database in memory.

At ACT 508, the method 500 can include receiving a request. The request can be a request for a path to a destination. The data processing system can receive the request from an electric vehicle or from a computing device (e.g., a mobile computing device, such as a cellular phone or a tablet). The request can include an identification of a destination (e.g., an address, coordinates, or a name of a location). The request can include geolocation data (e.g., coordinates) indicating the current location of the electric vehicle or computing device that transmitted the request.

At ACT 510, the method 500 can include identifying locations. The data processing system can identify the current location of the electric vehicle or the computing device that transmitted the request and the location of the destination. The data processing system can identify the current location of the electric vehicle from the geolocation data that was included with the request. The data processing system can identify the destination based on the data in the request or by using a look-up technique on a stored database using the identification of the destination as a key. The data processing system can identify the coordinates or location of the destination from the database or from the request.

At ACT 512, the method 500 can include determining whether the electric vehicle will need to be charged to reach the destination from the current location. The data processing system can determine whether the electric vehicle will need to be charged based on the current state of charge of the electric vehicle. For example, the data processing system can receive the current state of charge of the electric vehicle in the request for the path to the destination. The data processing system can receive characteristics of the electric vehicle (e.g., vehicle make, vehicle model, vehicle year, or vehicle type) in the request. The data processing system can store a table indicating estimated distances that different vehicles can travel on different states of charge. The table can include such distances across different terrains or areas. The data processing system can compare the state of charge and received characteristics of the vehicle, in some cases with the location or terrain in which the vehicle will be traveling, with the table to determine a distance the electric vehicle can travel towards the destination. The data processing system can compare the distance to the total distance to the destination. Responsive to determining the total distance is larger than the distance the electric vehicle can travel, the data processing can determine chargers to include in the path from the current location of the vehicle to the destination.

For example, at ACT 514, the data processing system can identify a subset of chargers. The subset of chargers can be or include chargers that the data processing system can include in a path from the current location of the electric vehicle to the destination for the electric vehicle. The data processing system can identify the subset of chargers based on the subset being between the current location of the vehicle and the destination. The data processing system can do so, for example, by determining an initial path from the current location of the electric vehicle to the destination. The data processing system can identify the locations of the chargers (e.g., the locations determined based on the geolocation data of the charging sessions) that are within a distance threshold of at least one point on the initial path. In doing so, the data processing system can reduce the number of chargers to select from for charging the electric vehicle on the path to chargers that would not add an unreasonable amount of time to the path (e.g., the data processing system can remove any chargers that would cause the electric vehicle to go multiple hours out of the way for charging).

At ACT 516, the data processing system can generate a path. The path can be a sequence of roads and turns for the electric vehicle to travel from the current location of the electric vehicle to the destination indicated in the request. Responsive to determining the state of charge of the electric vehicle is not enough to reach the destination, the data processing system can generate the path to include one or more chargers at which the electric vehicle is scheduled to charge to ensure the electric vehicle has enough charge to reach the destination. Otherwise, the data processing system may not take chargers into account when generating a path. The data processing system can select chargers to include in the path by determining added times for the subset of chargers identified in ACT 514. The data processing system can determine the added times for the subset of chargers (e.g., only the subset of chargers) as a function of or based on one or more of the scores for the chargers, the time traveling to the chargers and back to the road would add to the total travel time, the total charge time, or the expected wait time at the respective chargers. The data processing system can determine the total charge time or the expected wait time based on data regarding charging sessions that the data processing system receives from other electric vehicles, for example. The data processing system can select chargers in incremental steps towards the destination based on the current state of charge of the electric vehicle (e.g., using the table stored in memory based on the characteristics of the electric vehicle or the terrain) to ensure the electric vehicle has enough charge to reach the next selected charger. In selecting the chargers, the data processing system can select the chargers that have the lowest added times and are within range of the electric vehicle from the previous chargers (e.g., within a cushion threshold, such as within 10%). The data processing system can select chargers to generate a path that enables the electric vehicle to have enough charge to reach the destination while reducing the added time that charging adds to the trip. The data processing system can incorporate the selected chargers into a path that minimizes the total drive time from the current location of the electric vehicle to the destination.

At ACT 518, the data processing system updates a user interface. The user interface can be a user interface displaying an overhead map of the area surrounding the electric vehicle. The user interface can be displayed on a display of the electric vehicle (e.g., on the dashboard or table connected with the electric vehicle) or a computing device. The user interface can be displayed on the electric vehicle or the computing device that transmitted the request. The data processing system can update the user interface by transmitting a message including the path (e.g., the path in a file with instructions to follow the path) to the electric vehicle or computing device with instructions to update the user interface to depict the path. The electric vehicle or computing device can receive the path and update the user interface to depict the path, such as by creating a line showing the path from the current location of the electric vehicle to the destination. A driver of the electric vehicle can drive to the destination following the path or the electric vehicle can autonomously follow the path.

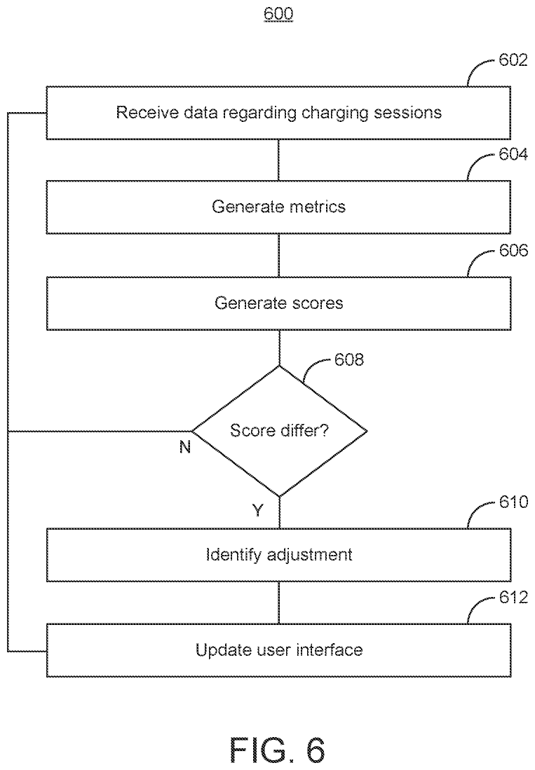

FIG. 6 depicts a method 600 of updating a user interface based on real-time charging session data, in accordance with present implementations. The method 600 can be performed by one or more components depicted in the system 200 of FIG. 2 or the computing device 900 of FIG. 9. For example, the method 600 can be performed by a data processing system (e.g., the data processing system 202, shown and described with reference to FIG. 2). Performance of the method 600 can allow the data processing system to use data regarding charging sessions to update a user interface. The data processing system can perform the method 600 after generating a user interface including visual indicators for different chargers that correspond to determined scores for the chargers, for example, and transmitting the user interfaces to one or more electric vehicles or computing devices for display.

At ACT 602, the method 600 can include receiving data regarding charging sessions. The data regarding charging sessions can be any type of data, such as geolocation data, an indication of whether the charging session succeeded or failed, temperature sensor data, or an amount of current that was delivered during the charging session. The data processing system can receive data regarding charging sessions from the electric vehicles being charged or the chargers charging the electric vehicles. The data processing system can receive the data at the end of the respective charging sessions or as the charging sessions are occurring. The data can include an identification of the vehicles participating in the charging sessions or an identification of the chargers charging the vehicles.

At ACT 604, the method 600 can include generating metrics. The data processing system can generate metrics for each charger for which the data processing system receives data regarding charging sessions. The metrics can be or include aggregate representations of specific types of data regarding charging sessions performed by individual chargers. The metrics can be or include actual delivered power for a given temperature, geolocation of a vehicle, time to begin charging session after entering an area around the charger, and charger health. The data processing system can generate the metrics by identifying the data of the same type for a charger and aggregating or performing a function, operation, rule, or condition on the data.

At ACT 606, the method 600 can include generating scores. The data processing system can generate a score for each charger for which the data processing system receives data regarding charging sessions. The data processing system can generate the scores based on or as a function of the data regarding charging sessions or the metrics that the data processing system generates based on the data regarding charging sessions for the individual chargers. For example, the data processing system can determine an average, sum, weighted average, weighted sum, a median, or any other function on all or a subset of the data regarding charging sessions or the metrics to generate scores for the chargers. The data processing system can store the scores in memory or in a database in memory.

At ACT 608, the method 600 can include determining whether any scores generated at ACT 606 differ from a previously scored score for the same charger. For example, the data processing system can perform the ACTs 602-606 over time, generating and storing scores for individual chargers for individual time periods. For each new score that the data processing system generates for a charger, the data processing system can replace a previously generated score for the charger with the new score in memory or add the new score to a data structure that contains or stores the scores for the charger. The data processing system can similarly generate and store new scores for each charger for which the data processing system receives data regarding charging sessions. For each charger, the data processing system can compare a newly generated score for the charger with the immediately previous score that the data processing system generated for the charger. The data processing system can identify any new scores that differ from the immediately previous score for the same charger and proceed to the ACT 610 for the chargers associated with the differing scores. The data processing system can return to the ACT 602 for the remaining chargers.

At ACT 610, the data processing system can identify an adjustment. The adjustment can be an adjustment to a user interface. The adjustment can be an adjustment to a visual indicator (e.g., a pin or any other shape that represents the individual chargers on specific locations on a map) for each charger that the data processing system determined corresponds to a newly generated score that differs from an immediately previously generated score for the same charger. The data processing system can identify adjustments that correspond to the newly generated scores. For example, the data processing system can determine, based on the new scores, new colors for the indicators of the chargers, new transparencies of the indicators of the chargers, or new numerical values for the chargers. The data processing system can determine which indicators for chargers to display responsive to determining which chargers correspond to scores above a threshold.

At ACT 612, the data processing system can update a user interface. The data processing system can update the user interfaces of electric vehicles or computing devices that were previously displayed to include an overhead view of a map with different visual indicators indicating the locations of different chargers. The visual indicators may have been illustrated based on scores that were previously determined for the chargers (e.g., illustrated with colors, transparencies, or numbers determined based on previously determined scores for the chargers). The data processing system can transmit the newly determined visual indicators for the chargers with identifications of the corresponding chargers to one or more electric vehicles or computing devices for which the data processing system had previously transmitted visual indicators for chargers. The electric vehicles or computing devices can receive the new visual indicators and identification of the chargers and update the user interfaces of the electric vehicles or computing devices to show the new visual indicators for the chargers in place of the previous visual indicators for the chargers. The computing devices or electric vehicles can remove or add visual indicators for chargers to the user interface responsive to the data processing system determining new scores for chargers are below or exceed a threshold, respectively.

The data processing system can selectively transmit new visual indicators to different electric vehicles or computing devices. The data processing system can do so using geolocation data of the electric vehicles or computing devices. For example, prior to transmitting the new visual indicators for the chargers to the electric vehicles or computing devices, the data processing system can poll different electric vehicles or computing devices for current geographic locations for the respective electric vehicles or computing devices. The electric vehicles or computing devices can respond with geolocation data indicating the current locations of the electric vehicles or computing devices. The data processing system can identify the locations of the chargers, which can be the locations the data processing system received in specifications for the chargers or locations determined for the chargers based on data of charging sessions performed at the chargers. The data processing system can identify chargers for which the data processing system generated differing scores that are within a radius (e.g., a defined radius) of the respective electric vehicles or computing devices. The data processing system can transmit new visual indicators for the chargers to the electric vehicles or computing devices that are within the radius of the respective electric vehicles or computing devices to update the user interfaces at the electric vehicles or computing devices. Thus, the data processing system can avoid transmitting data to electric vehicles or computing devices that may not be relevant to the respective electric vehicles or computing devices (e.g., the data processing system may not transmit new visual indications for chargers that are across the country from an electric vehicle or computing device).

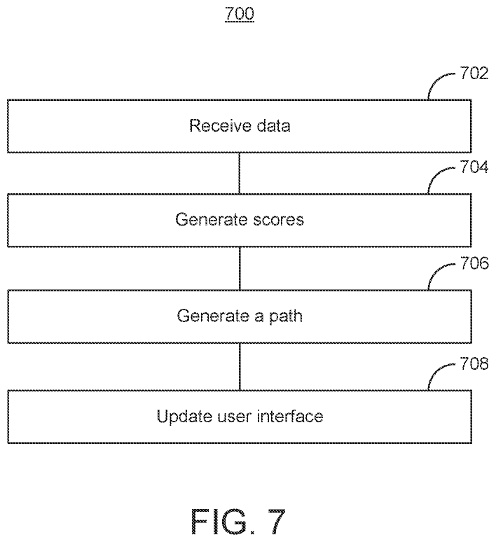

FIG. 7 depicts a method 700 of managing electric vehicle charging during path planning, in accordance with present implementations. The method 700 can be performed by one or more components depicted in the system 200 of FIG. 2 or the computing device 900 of FIG. 9. For example, the method 700 can be performed by a data processing system (e.g., the data processing system 202, shown and described with reference to FIG. 2). Performance of the method 500 can allow the data processing system to use data regarding charging sessions for path planning.

At ACT 702, the method 700 can include receiving data regarding charging sessions. The data processing system can receive the data regarding charging sessions from the electric vehicles or chargers participating in the charging sessions. At ACT 704, the method 700 can include generating scores. The data processing system can generate one or more metrics for individual chargers based on charging sessions performed at the respective chargers. The data processing system can generate scores for the individual chargers based on the metrics or data regarding charging sessions for the chargers. At ACT 706, the method 700 can include generating a path. The data processing system can use the generated scores to determine added times for different chargers that are between the current location of an electric vehicle and a destination. The data processing system can use the added times of the chargers to generate a path for the electric vehicle that includes chargers that enable the electric vehicle to maintain enough charge for the electric vehicle to reach the destination. The data processing system can generate the path to take the lowest amount of time taking into account the added time of traveling to and charging at the chargers on the path.

At ACT 708, the method 700 can include updating a user interface. The user interface can be a user interface being displayed on a computing device or an electric vehicle depicting an overhead map of the area surrounding the electric vehicle. The data processing system can update the user interface to display the path by transmitting the path to the electric vehicle or computing device presenting the user interface. The electric vehicle or computing device can display the path on the user interface by showing a line representing the path for the electric vehicle to take to reach the destination, including stops at the selected chargers for charging. A driver driving the electric vehicle can follow the path to reach the destination or the electric vehicle can autonomously follow the path to reach the destination.

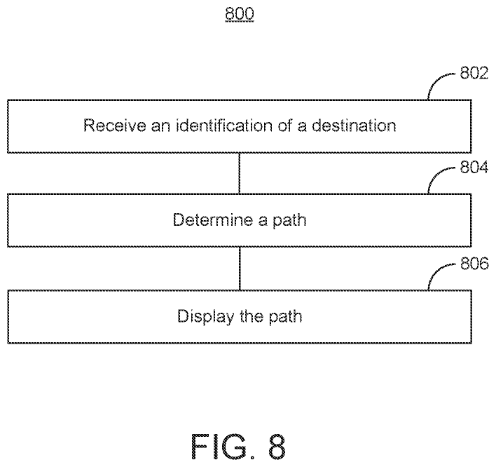

FIG. 8 depicts a method 800 of managing electric vehicle charging during path planning, in accordance with present implementations. The method 800 can be performed by one or more components depicted in the system 200 of FIG. 2 or the computing device 900 of FIG. 9. For example, the method 800 can be performed by a data processing system (e.g., the data processing system 202, shown and described with reference to FIG. 2). The data processing system can include one or more processors located on an electric vehicle. Performance of the method 800 can allow the data processing system to display a path from a current location of the electric vehicle to a destination that includes one or more chargers for charging the electric vehicle.

At ACT 802, the method 800 includes receiving an identification of a destination. The identification of the destination can be a string identifying a name of the destination, coordinates of the destination, audio identifying the destination, or any other identification of the destination. The identification of the destination can be provided as a user input. The data processing system can receive the identification as a request for a path to travel from the current location to the destination.

At ACT 804, the method 800 includes determining a path. The path can be a path from the current location of the electric vehicle to the destination. The data processing system can determine the path by implementing the ACTs of the method 500 or the method 700. For example, the data processing system can determine the path according to a score for each of a plurality of chargers between the current location of the electric vehicle and the destination based at least on data regarding charging sessions performed at the chargers. The path can include a location for each of at least one of the plurality of chargers selected at least based on the scores. The data processing system can transmit the identification of the destination and geolocation data indicating the current location of the electric vehicle to a remote server or computer. The remote server or computer can implement the ACTs of the method 500 or the method 700 to generate the path and transmit the path back to the data processing system of the electric vehicle. The data processing system can determine the path by identifying the path generated by the remote server or computer.

At ACT 806, the method can include displaying the path. The data processing system can display the path on a user interface depicting an overhead map of the area surrounding the electric vehicle to the current location. The data processing system can update the user interface to show a line from the current location of the electric vehicle to the destination. An individual driving the electric vehicle can drive along the path to reach the destination from the current location of the electric vehicle.

FIG. 9 depicts an example block diagram of an example computer system 900, in accordance with some implementations. The computer system or computing device 900 can include or be used to implement a data processing system or its components. The computing system 900 includes at least one bus 905 or other communication component for communicating information and at least one processor 910 or processing circuit coupled to the bus 905 for processing information. The computing system 900 can also include one or more processors 910 or processing circuits coupled to the bus for processing information. The computing system 900 also includes at least one main memory 915, such as a random access memory (RAM) or other dynamic storage device, coupled to the bus 905 for storing information, and instructions to be executed by the processor 910. The main memory 915 can be used for storing information during execution of instructions by the processor 910. The computing system 900 can further include at least one read only memory (ROM) 920 or other static storage device coupled to the bus 905 for storing static information and instructions for the processor 910. A storage device 925, such as a solid state device, magnetic disk or optical disk, can be coupled to the bus 905 to persistently store information and instructions.

The computing system 900 can be coupled via the bus 905 to a display 935, such as a liquid crystal display, or active matrix display, for displaying information to a user such as a driver of the electric vehicle 105 or other end user. An input device 930, such as a keyboard or voice interface can be coupled to the bus 905 for communicating information and commands to the processor 910. The input device 930 can include a touch screen display 935. The input device 930 can also include a cursor control, such as a mouse, a trackball, or cursor direction keys, for communicating direction information and command selections to the processor 910 and for controlling cursor movement on the display 935.

The processes, systems and methods described herein can be implemented by the computing system 900 in response to the processor 910 executing an arrangement of instructions contained in main memory 915. Such instructions can be read into main memory 915 from another computer-readable medium, such as the storage device 925. Execution of the arrangement of instructions contained in main memory 915 causes the computing system 900 to perform the illustrative processes described herein. One or more processors in a multi-processing arrangement can also be employed to execute the instructions contained in main memory 915. Hard-wired circuitry can be used in place of or in combination with software instructions together with the systems and methods described herein. Systems and methods described herein are not limited to any specific combination of hardware circuitry and software.

Although an example computing system has been described in FIG. 9, the subject matter including the operations described in this specification can be implemented in other types of digital electronic circuitry, or in computer software, firmware, or hardware, including the structures disclosed in this specification and their structural equivalents, or in combinations of one or more of them.

Although an example computing system has been described in FIG. 9, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
one or more processors, coupled with memory, to:
receive data regarding charging sessions of electric vehicles at a plurality of chargers;
generate a score for each of the plurality of chargers based at least on the data regarding the charging sessions;
generate a path from a current location of a vehicle to a destination that includes a location for each of at least one of the plurality of chargers selected at least based on the scores; and
update a user interface to depict the path including the location for each of the at least one of the plurality of chargers.

2. The system of claim 1, comprising the one or more processors to:
receive geolocation data of the charging sessions at the plurality of chargers; and
determine the location for each of the at least one of the plurality of chargers based on the geolocation data of charging sessions at the at least one charger.

3. The system of claim 1, comprising the one or more processors to:
aggregate the data regarding the charging session into a plurality of metrics for each of one or more of the plurality of chargers, the plurality of metrics comprising actual delivered power for a given temperature or an average time to begin a charging session; and
generate the score for each of the one or more of the plurality of chargers based at least on the plurality of metrics aggregated for the charger.

4. The system of claim 1, comprising the one or more processors to:
generate the score for each of the plurality of chargers based at least on the data regarding the charging sessions and specifications for the plurality of chargers.

5. The system of claim 1, comprising the one or more processors to:
determine an added time for each of the plurality of chargers based at least on the score of the charger; and
select the at least one of the plurality of chargers based on the added times.

6. The system of claim 1, comprising the one or more processors to:
select the at least one of the plurality of chargers based at least on the scores and average amounts of current delivered during the charging sessions.

7. The system of claim 1, comprising the one or more processors to:
display visual indicators for one or more of the plurality of chargers on the user interface; and
adjust the visual indicators for the one or more chargers proportional to the scores for the at least one charger.

8. The system of claim 1, comprising the one or more processors to:
generate a health score for each of the plurality of chargers based at least on the data regarding the charging sessions; and
select the at least one charger based on the health scores.

9. The system of claim 1, comprising the one or more processors to:
identify a subset of the plurality of chargers based on the subset being between the current location of the vehicle and the destination; and
select the at least one of the plurality of chargers based at least on the scores of the subset of the plurality of chargers.

10. The system of claim 1, comprising the one or more processors to:
store the scores for the plurality of chargers in the memory;
subsequent to storing the scores in the memory, receive, from the vehicle, a request to generate the path;
responsive to receiving the request, retrieve the scores for the plurality of chargers from the memory; and
generate the path using the retrieved scores for the plurality of chargers.

11. The system of claim 1, wherein the scores are first scores and the data regarding charging sessions of electric vehicles at the plurality of chargers is first data regarding charging sessions of electric vehicles at the plurality of chargers, and comprising the one or more processors to:
receive, during a first time period, the first data regarding charging sessions of electric vehicles at the plurality of chargers;
generate the first score for each of the plurality of chargers based at least on the first data regarding the charging sessions;
store the first scores for the plurality of chargers in the memory;
receive, during a second time period subsequent to the first time period, second data regarding charging sessions of electric vehicles at the plurality of chargers;
generate a second score for each of the plurality of chargers based at least on the second data regarding the charging sessions; and
replace the first scores for the plurality of chargers in the memory with the second scores for the plurality of chargers in the memory.

12. The system of claim 1, wherein the data regarding the charging sessions comprises, for a charging session of the charging sessions, geolocation data, an indication of whether the charging session succeeded or failed, temperature sensor data, or an amount of current that was delivered.

13. A method, comprising:
receiving, by one or more processors, data regarding charging sessions of electric vehicles at a plurality of chargers;
generating, by the one or more processors, a score for each of the plurality of chargers based at least on the data regarding the charging sessions;
generating, by the one or more processors, a path from a current location of a vehicle to a destination that includes a location for each of at least one of the plurality of chargers selected at least based on the scores; and
updating, by the one or more processors, a user interface to depict the path including the location for each of the at least one of the plurality of chargers.

14. The method of claim 13, comprising:
receiving, by the one or more processors, geolocation data of the charging session at the plurality of chargers; and
determining, by the one or more processors, the location for each of the at least one of the plurality of chargers based on the geolocation data of charging sessions at the at least one charger.

15. The method of claim 13, comprising:
aggregating, by the one or more processors, the data regarding the charging session into a plurality of metrics for each of one or more of the plurality of chargers, the plurality of metrics comprising actual delivered power for a given temperature, an average time to begin a charging session, or a health of a charger; and
generating, by the one or more processors, the score for each of the one or more of the plurality of chargers based at least on the plurality of metrics aggregated for a charger.

16. The method of claim 13, comprising:
generating, by the one or more processors, the score for each of the plurality of chargers based at least on the data regarding the charging sessions and specifications for the plurality of chargers.

17. The method of claim 13, comprising:
comparing, by the one or more processors, the scores for the plurality of chargers; and
selecting, by the one or more processors, the at least one of the plurality of chargers responsive to determining the scores of the at least one of the plurality of chargers satisfy a condition.

18. A vehicle, comprising:
one or more processors, coupled with memory, to:
receive an identification of a destination;
determine a path from a current location of the vehicle to the destination,
wherein the path is determined according to a score for each of a plurality of chargers based at least on data regarding charging sessions performed at the plurality of chargers, the path including a location for each of at least one of the plurality of chargers selected at least based on the scores; and
display the path including the location for each of the at least one of the plurality of chargers.

19. The vehicle of claim 18, comprising the one or more processors to:
display visual indicators for one or more of the plurality of chargers on a user interface; and
adjust the visual indicators for the one or more chargers proportional to the scores for the at least one charger.

20. The vehicle of claim 18, wherein the data regarding the charging sessions comprises, for a charging session of the charging sessions, geolocation data, an indication of whether the charging session succeeded or failed, temperature sensor data, or an amount of current that was delivered.
